(19) United States
(12) Patent Application Publication
(10) Pub. No.: US 2023/0120022 A1
(43) Pub. Date: Apr. 20, 2023

(54) ENVIRONMENT-BASED THERMAL MANAGEMENT

(71) Applicant: Lunar Outpost Inc., Golden, CO (US)

(72) Inventors: Andrew Josef Gemer, Lafayette, CO (US); Colby Moxham, Golden, CO (US)

(21) Appl. No.: 18/048,020

(22) Filed: Oct. 19, 2022

Related U.S. Application Data
(60) Provisional application No. 63/257,303, filed on Oct. 19, 2021.

(51) Int. Cl. G05D 1/00; G05D 1/02

(52) U.S. Cl. CPC G05D 1/0088; G05D 1/0214; G05D 1/0234

(57) ABSTRACT

Aspects of the present disclosure relate to environment-based thermal management. In examples, an environment is evaluated using a network of temperature sensors. Additionally, or alternatively, the environment is evaluated using an infrared and/or visible light camera. Candidate features of the environment having associated thermal conditions (e.g., surface temperature, geometry of an environmental feature, and/or degree of exposure to deep space) are detected and used to position a rover, robot, or other hardware within the environment, thereby causing the temperature of the hardware to be mediated by its exposure to features of the environment. Additionally, the rover may reposition itself within the environment in response to changing thermal conditions within the environment and/or changing thermal demands of the rover.

### CROSS-REFERENCE TO RELATED APPLICATION

This application claims priority to U.S. Provisional Application No. 63/257,303, titled “An System for Autonomously Detecting and Utilizing Environmental Conditions to Control a Vehicle's Thermal Conditions: Polar In-Situ Thermal Tracking (PITT™),” filed on Oct. 19, 2021, the entire disclosure of which is hereby incorporated by reference in its entirety.

### BACKGROUND

Vehicles, electronic devices, and other hardware have a range of operating temperatures, outside of which, unexpected or unintended operation, or even failure, may result. For example, a mechanical component may seize and/or an electronic component may no longer function above a maximum temperature or below a minimum temperature. In some examples, damage may result outside of such operating temperature ranges. For instance, the lunar surface exhibits a wide range of temperatures, and the extreme cold of the lunar night often causes mechanical and electrical components of landers, rovers, and other hardware to fail.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to environment-based thermal management. In examples, an environment is evaluated using a network of temperature sensors. Additionally, or alternatively, the environment is evaluated using an infrared and/or visible light camera. Candidate features of the environment having associated thermal conditions (e.g., surface temperature, geometry of an environmental feature, and/or degree of exposure to deep space) are detected and used to position a rover, robot, or other hardware within the environment, thereby causing the temperature of the hardware to be mediated by its exposure to features of the environment. Additionally, the rover may reposition itself within the environment in response to changing thermal conditions within the environment and/or changing thermal demands of the rover.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates a conceptual diagram of an example vehicle with which environment-based thermal management may be used according to aspects described herein.

FIG. 2 illustrates a top-down view of an example environment in which aspects of environment-based thermal management may be performed according to the present disclosure.

FIG. 3A illustrates an overview of an example method for environment-based thermal management according to aspects described herein.

FIG. 3B illustrates an overview of another example method for environment-based thermal management according to aspects described herein.

FIG. 4 illustrates an overview of an example method for evaluating candidate positions around a candidate feature according to aspects described herein.

FIG. 5 illustrates an example of a suitable computing environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Some electrical and mechanical hardware operate in environments having a high degree of temperature variability. This is especially true for hardware operating on the Moon or on Mars, among other examples. For instance, a lander or rover on the Moon may be at least partially exposed to deep space, such that, in the absence of energy from the Sun, heat is radiated into deep space, thereby resulting in extremely low temperatures. Similarly, a high degree of solar radiation may be received during the lunar day, which may result in very high temperatures. Thus, it is difficult to regulate the temperature of hardware in these environments to avoid exceeding a range of operating temperatures for the hardware.

Accordingly, aspects of the present application relate to environment-based thermal management. In examples, thermal conditions within an environment (e.g., surface temperature, geometry of an environmental feature, and/or degree of exposure to deep space) are detected and used to position a rover, robot, or other hardware within the environment, thereby causing the temperature of the hardware to be mediated by its exposure to features of the environment. Additionally, the rover may reposition itself within the environment in response to changing thermal conditions within the environment and/or changing thermal demands of the rover.

As an example, a rover operating on the lunar surface according to aspects described herein identifies a boulder or other environmental feature that radiates heat or otherwise shields the rover from deep space to some degree. The rover positions itself near the environmental feature (e.g., a warm side of the boulder, having just been warmed by the Sun) to increase or maximize the degree to which it is warmed by the heat radiated from the environmental feature. As another example, the rover positions itself to reduce or obstruct its view to deep space, thereby increasing the heat retained by the rover. As the thermal conditions within the environment change (e.g., overnight), the rover reevaluates the environment and reorients/repositions itself to improve the likelihood that the rover “survives” (e.g., maintains a temperature within an operating temperature range) the lunar night. Similarly, under hot conditions, the rover identifies comparatively cooler locations (e.g., the cooler side of the bolder, shielded from the Sun) and positions itself to reduce or minimize the amount of radiative heat received by the rover and/or increases the amount of heat that is radiated from the rover into the environment.

Thus, the disclosed aspects improve the rover's ability to maintain its temperature within an operating temperature range, while potentially reducing the amount of hardware needed by the rover for thermal management. For instance, in contrast to examples where a sunshield and/or heater are included to address such environmental extremes, the disclosed aspects are primarily software-based (in addition to sensors, compute resources, and other hardware associated with implementing the disclosed environment-based thermal management techniques).

While aspects are described with respect to certain environmental features a planetary body (e.g., the Moon, Mars, or Earth), it will be appreciated that similar techniques are applicable to any of a variety of other features within an environment, including, but not limited to, buildings, walls, vehicles, or foliage, among other examples. Additionally, the disclosed aspects may be used for thermal management of a rover or other hardware in any of a variety of scenarios. For example, a rover evaluates its environment prior to the lunar night to identify a location at which to park overnight (e.g., during an anticipated period of extreme cold). As noted above, the rover may reevaluate the environment and reposition itself as needed throughout the night. As another example, a rover navigates across the lunar surface and applies the disclosed aspects to generate a route across the surface to a given location that reduces or minimizes its exposure to heat (or increase exposure to heat in other examples).

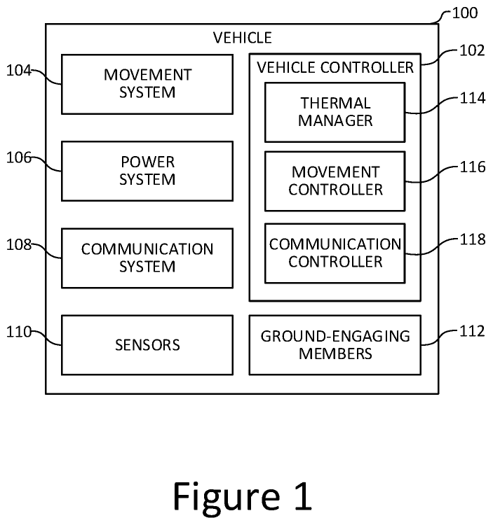

FIG. 1 illustrates a conceptual diagram of an example vehicle 100 with which environment-based thermal management may be used according to aspects described herein. As noted above, the disclosed aspects may similarly be implemented by any of a variety of other types of hardware in other examples. As illustrated, vehicle 100 includes vehicle controller 102, movement system 104, power system 106, communication system 108, sensors 110, and ground-engaging members 112.

It will be appreciated that vehicle 100 may be any of a variety of vehicles, including, but not limited to, a rover or a robot. Vehicle 100 is illustrated as further including one or more ground-engaging members 112. Example ground-engaging members include, but are not limited to, wheels or tracks. In examples, vehicle 100 may be remotely controlled (e.g., via communication system 108) and/or may be autonomously controlled (e.g., as may be affected by vehicle controller 102).

Movement system 104 may include a prime mover (e.g., an electric motor or an internal combustion engine) to power ground-engaging members 112, as well as a steering system, which may control a steering angle of one or more ground-engaging members 112 and/or may cause ground-engaging members 112 to be powered differently to achieve rotation about an axis. In examples, movement controller 116 of vehicle controller 102 controls movement system 104 to affect movement of vehicle 100 accordingly. For example, movement controller 116 may cause movement system 104 to propel vehicle 100 forward, backward, or in any of a variety of other directions. Movement controller 116 may control movement system 104 according to one or more commands that are received by vehicle 100 (e.g., via communication system 108) from a remote device (not pictured) and/or may control movement system 104 at least partially automatically (e.g., based on data from sensors 110; according to the disclosed environment-based thermal management aspects).

Power system 106 may provide electrical power to movement system 104, communication system 108, and/or vehicle controller 102, among other examples. In examples, power system 106 includes a battery and a solar panel with which to recharge the battery. As another example, power system 106 may include a radioisotope thermoelectric generator. Thus, it will be appreciated that vehicle 100 may include any of a variety of power sources and, similarly, any of a variety of movement systems may be used to propel vehicle 100 accordingly.

Communication system 108 may include any of a variety of communication technologies to provide wired and/or wireless communication for vehicle 100. Communication controller 118 of vehicle controller 102 may control communication system 108, thereby enabling communication to and/or from vehicle 100. For example, communication controller 118 may configure one or more radios of communication system 108 and/or may establish a connection with one or more remote devices (not pictured).

Sensors 110 of vehicle 100 may include any of a variety of sensors, including, but not limited to, image capture devices (e.g., visible light and/or infrared cameras), light sensors, proximity sensors, temperature sensors (e.g., thermocouples or thermistors), three-dimensional mapping sensors (e.g., using multiple image capture devices or a light detection and ranging (LIDAR) system), and/or chemical composition sensors, among other examples.

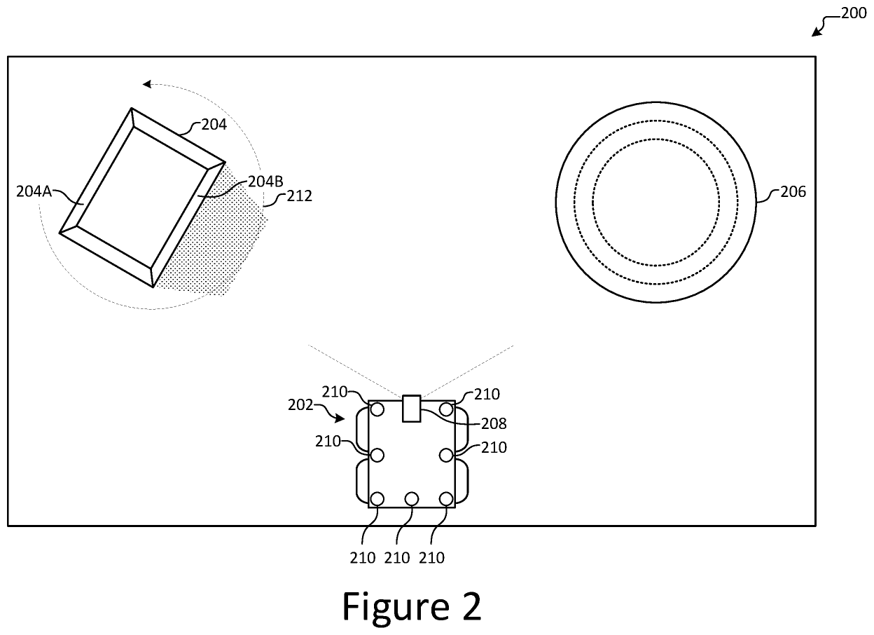

In examples, sensors 110 includes a network of temperature sensors (e.g., multiple sensors, such as sensors 210 in FIG. 2, which are discussed below in greater detail), thereby enabling vehicle 100 to sense a temperature gradient and thus navigate toward an area of relative heat or relative cool. In an example, at least some of the temperature sensors are outward-facing sensors, such that the temperature external to the vehicle is sensed. As another example, at least some of the temperature sensors are internal to vehicle 100, thereby enabling thermal manager 114 to monitor the temperature of various components of vehicle 100.

Sensors 110 may include any of a variety of additional or alternative sensors for environment-based thermal management. As an example, sensors 110 includes one or more proximity and/or LIDAR sensors, thereby enabling vehicle 100 to detect the geometry of features within its environment and thus use such features to limit its exposure to deep space.

As another example, sensors 110 includes a visible light and/or IR camera, which may provide additional detail as compared to the above-described network of temperature sensors. However, including an image capture device may introduce additional power consumption, weight, and/or design complexity as compared to a network of temperature sensors. In some instances, the camera is used to obtain initial information about environment features around the vehicle, after which the network of temperature sensors is used for subsequent navigation and/or evaluating identified environmental features in more detail.

Similarly, a three-dimensional (3D) representation of an environment may be generated based on mono or stereo image data, or based on LIDAR data, among other examples. In some instances, the 3D representation is generated for another process performed by vehicle 100, such that additional LIDAR hardware need not be specifically included for environment-based thermal management according to aspects described herein. Accordingly, the 3D representation of the vehicle's environment is processed to identify candidate environmental features for subsequent evaluation (e.g., via the network of thermal sensors).

Such “hybrid” approaches (e.g., using an image capture device or LIDAR system in addition to a network of thermal sensors) may reduce energy and/or computer resource consumption, while still gaining the benefit of improved environmental understanding based on such data.

Vehicle controller 102 is illustrated as further comprising thermal manager 114. In examples, thermal manager 114 evaluates the environment in which vehicle 100 is operating (e.g., via sensors 110) to identify a location with which to manage the temperature of vehicle 100. For example, thermal manager 114 obtains sensor data from sensors 110 and processes the sensor data to identify a set of candidate features within the environment. Example features include, but are not limited to, rocks, boulders, craters, caves, hills, or other feature on or region of a planetary body. As noted above, the features may be identified based on image data (e.g., obtained from an image capture device) and/or based on a 3D representation of the environment (e.g., obtained via computer vision techniques and/or LIDAR), among other examples.

Thermal manager 114 evaluates identified features (which may also be referred to herein as “candidate features”) to determine associated thermal conditions. For example, thermal manager 114 determines a surface temperature and/or geometry of a given candidate feature (and, thus, a degree to which the feature may shield vehicle 100 from deep space). As another example, thermal manager 114 measures, models, or otherwise estimates the radiative and/or absorptive properties of a candidate feature (e.g., based on the material composition, density, and/or geometry of the candidate feature). Such models may be generated and/or maintained by thermal manager 114 (e.g., based on previous observations of the same or similar features). Additionally, or alternatively, one or more models are obtained and/or updated by a remote device (not pictured).

As a result of these or other similar analyses, thermal manager 114 determines an estimated thermal effect on vehicle 100 for a candidate feature. For instance, thermal manager 114 determines a boulder is estimated to radiate an amount of heat energy that permits vehicle 100 to maintain a temperature above a predetermined threshold for a given amount of time (e.g., during the lunar night).

Thermal manager 114 may thus rank candidate features according to such determined thermal conditions. For instance, the thermal manager ranks the candidate features according to a thermal goal for the vehicle (e.g., whether the vehicle is to be cooled or heated). The thermal goal may be determined based on one or more temperature sensors of the vehicle (e.g., sensors 110; in view of an associated minimum and/or maximum operating temperature), such that a vehicle temperature and/or a temperature of a constituent component may be used to determine whether the vehicle should be heated or cooled. In an instance where the candidate features are ranked in view of a thermal goal to heat the vehicle, candidate features having a thermal effect that would warm the vehicle may be ranked more highly than candidate features having a thermal effect that would cool the vehicle (e.g., that would cause heat to be radiated from the vehicle). Similarly, candidate features having a higher degree of warming would be ranked more highly than candidate features having a lower degree of warming.

In examples, ranking the set of candidate features further comprises evaluating one or more costs associated with a given candidate feature, such as the cost of maneuvering to/from the candidate feature, a restriction on vehicle mobility and/or other functionality (e.g., relating to terrain or obscured availability of solar energy), or a reduced ability to perform aspects of a given mission, among other costs. Thus, in some examples, thermal manager 114 weighs an estimated thermal benefit of a candidate feature with an estimated cost of maneuvering vehicle 100 to use the candidate feature for thermal management according to aspects described herein.

In another example, thermal manager 114 processes data from a network of thermal sensors to identify a temperature gradient within the environment, such that thermal manager 114 may determine to maneuver vehicle 100 toward a region of relative heat or relative cool (depending on whether vehicle 100 is to be heated or cooled). In examples, such aspects are performed once a candidate feature has been selected, for example to identify a specific position in relation to a feature to which vehicle 100 is maneuvered for thermal management. Similarly, thermal manager 114 may determine an orientation for the vehicle (e.g., rotating vehicle 100 about an axis to orient the vehicle in a certain way relative to the environmental feature). Thus, positioning vehicle 100 may comprise maneuvering vehicle 100 to a given location and/or orienting vehicle 100 in a given direction in relation to an environmental feature.

Thermal manager 114 may collect telemetry data associated with the disclosed environment-based thermal management techniques, which may be stored by vehicle controller 102 and/or transmitted to a remote device (e.g., via communication system 108). For example, thermal manager 114 may store an estimated thermal effect and an observed thermal effect (e.g., as may be determined via sensors 110) as telemetry data. Additionally, or alternatively, thermal manger 114 may store information relating to an associated environmental feature. Such telemetry data may be used to generate a new model or improve an existing model for modeling a thermal effect of an environmental feature (e.g., on vehicle 100) based on associated thermal conditions. For example, modeling may improve with respect to determining the radiative/absorptive heat transfer for a given environmental feature having a given set of thermal conditions, as well as with respect to determining the effect of such heat transfer on vehicle 100 and/or constituent components of vehicle 100. Thus, the predictive capability of thermal manager 114 may improve as additional telemetry data is generated for a variety of scenarios, environments, and/or environmental features therein.

While example processing is described above with respect to thermal manager 114, it will be appreciated that at least a part of such processing may be performed by a remote computing device in other examples. For example, telemetry data generated by thermal manager 114 may be transmitted to a remote computing device for processing, such that the remote computing device generates a new or updated model accordingly. As another example, the remote computing device may generate a new or updated model based on telemetry data from another thermal manager (not pictured), such that the model is received by thermal manager 114 (e.g., via communication system 108) and used for subsequent thermal evaluations as described herein. Similarly, while examples described herein are in the context of autonomous thermal management, it will be appreciated that similar techniques may be used to provide an indication as to a selected candidate feature to a manual vehicle operator, such that the operator may use the indication to maneuver a vehicle (e.g., operating under remote control or a semi-autonomous mode) to the candidate feature.

FIG. 2 illustrates a top-down view of an example environment 200 in which aspects of environment-based thermal management may be performed according to the present disclosure. As illustrated, environment 200 includes vehicle 202, environmental feature 204, and environmental feature 206. Aspects of vehicle 202 may be similar to those discussed above with respect to vehicle 100 of FIG. 1 and are therefore not necessarily redescribed below in detail.

Environmental feature 204 includes first side 204A and second side 204B. As illustrated, first side 204A is exposed to the Sun, while second side 204B is shaded. Environmental feature 206 is a crater. If vehicle 202 maneuvered into environmental feature 206, it would experience reduced exposure to deep space, thereby reducing the amount of heat that is radiated away from vehicle 202 into deep space.

Vehicle 202 is illustrated as comprising image capture device 208 and thermal sensors 210. A thermal manger of vehicle 202 (aspects of which may be similar to thermal manager 114 in FIG. 1) processes data from image capture device 208 and thermal sensors 210 to manage the temperature of vehicle 202 according to aspects described herein. For example, it may be determined that first side 204A of environmental feature 204 received solar energy more recently than second side 204B, such that first side 204A can be used to warm vehicle 202 accordingly. By contrast, if vehicle 202 is to be cooled, second side 204B of environmental feature 204 may be identified as a candidate feature at which to position vehicle 202.

With respect to environmental feature 206, it may be determined that vehicle 202 is able to shield itself from deep space to a higher degree than the location at which it is illustrated. Thus, the thermal manager of vehicle 202 may determine to maneuver vehicle 202 into environmental feature 206 in instances where reduced heat loss is beneficial.

Vehicle 202 may be repositioned according to the described aspects of environment-based thermal management. In the context of environment 200, vehicle 202 may first be positioned near second side 204B of environmental feature 204 during the day, thereby shielding vehicle 202 from solar energy and maintaining a temperature below its maximum operating temperature.

Path 212 is illustrated to provide an example in which vehicle 202 circumnavigates environmental feature 204 to better characterize its thermal condition (e.g., using thermal sensors 210). It will be appreciated that vehicle 202 need not circumnavigate environmental feature 204 in its entirety, such that vehicle 202 may survey only a portion of environmental feature 204. For example, vehicle 202 stops once a position having a desired temperature or thermal effect is identified.

However, as the Sun begins to set, vehicle 202 may determine to maneuver to first side 204A of environmental feature 204 based on determining the thermal effect of first side 204A is to warm vehicle 202 during the lunar night (thereby maintaining a temperature above its minimum operating temperature).

After some time (e.g., once first side 204A has decreased in temperature or returned to a temperature similar to that of the lunar surface), it may be determined to reposition vehicle 202 into environmental feature 206, which offers improved shielding from deep space as compared environmental feature 204. Thus, as a result of maneuvering to environmental feature 206, the amount of heat lost by vehicle 202 may be reduced as compared to if vehicle 202 were instead shielded by environmental feature 204.

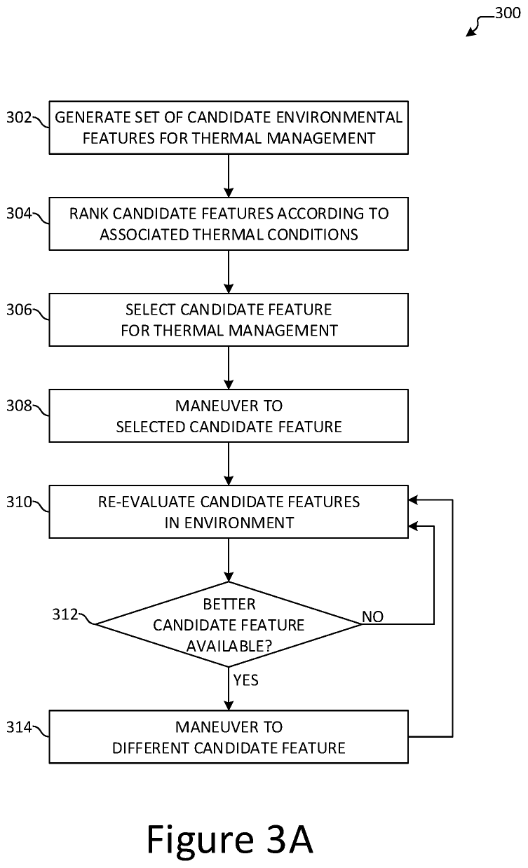

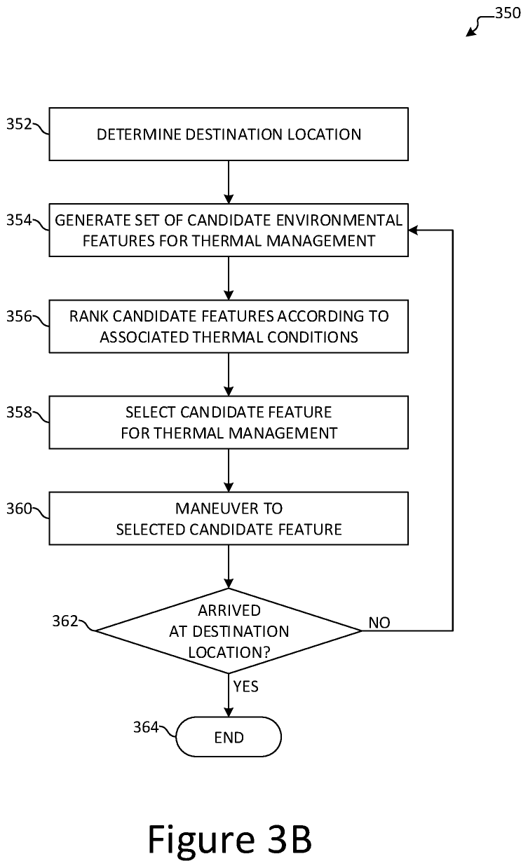

FIG. 3A illustrates an overview of an example method 300 for environment-based thermal management according to aspects described herein. In examples, aspects of method 300 are performed by a thermal manager, such as thermal manager 114 in FIG. 1. Aspects of method 300 may be performed by a vehicle (e.g., vehicle 100) among any of a variety of other hardware.

As illustrated, method 300 begins at operation 302, where a set of candidate environmental features is generated for thermal management. In examples, the set of candidate features is generated based on image data of the environment. Alternatively, or additionally, the set of candidate features is generated based on a 3D representation of the environment. In an example where such detailed environment information is not available, the set of candidate environmental features may be generated based on a temperature gradient (e.g., as may be detected based on a network of thermal sensors). In such an example, the candidate features may correspond to directions of travel of the vehicle.

Flow progresses to operation 304, where the candidate features are ranked according to associated thermal conditions. As noted above, a surface temperature, geometry, absorptivity, and/or emissivity of the candidate feature may be evaluated to determine an expected thermal effect that the candidate feature would have on the vehicle. In examples, operation 304 comprises obtaining information relating to such thermal conditions using sensors (e.g., sensors 110 in FIG. 1). The expected thermal effect may be generated based on one or more models (e.g., as may be maintained by a thermal manager and/or received from a remote computing device).

Thus, candidate features may be ranked according to an associated thermal effect (e.g., in view of a thermal goal, as described above). In other examples, candidate features are ranked according to an associated temperature (e.g., as may be the case when a temperature sensors are used to evaluate the environment of the vehicle). In some examples, candidate features are further ranked according to an associated cost, such that a benefit associated with a given candidate feature (e.g., an estimated thermal effect or an associated temperature) is offset based on an associated cost (e.g., the cost of maneuvering to/from the candidate feature, a restriction on vehicle mobility or other functionality, or a reduced ability to perform aspects of a given mission). Thus, it will be appreciated that candidate features may be ranked according to any of a variety of criteria.

At operation 306, a candidate feature is selected for thermal management. In examples, operation 306 comprises identifying the highest ranked candidate feature from the set of candidate features. While method 300 is provided as an example where candidate features are ranked and selected accordingly, it will be appreciated that any of a variety of other techniques may be used to select a candidate feature from a set of candidate features.

For example, the set of candidate features may be evaluated according to a set of rules. The set of rules may filter the set of candidate features (e.g., according to one or more thermal conditions, a direction of travel, a temperature threshold, or an associated cost), such that the remaining candidate features are evaluated at operation 306. In such an example, the remaining candidate features may be evaluated to determine which candidate feature has the lowest associated cost or the highest expected thermal effect, though any of a variety of additional or alternative criteria may be used in other examples.

Flow progresses to operation 308, where the vehicle maneuvers to the candidate feature that was selected at operation 306. In examples, operation 308 comprises providing an indication to a movement controller (e.g., movement controller 116 of vehicle controller 102 in FIG. 1), thereby causing the vehicle to maneuver to the selected candidate feature accordingly. While examples are described with respect to a single candidate feature, it will be appreciated that similar techniques may be used to select multiple candidate features (e.g., proximal to one another) with which to perform environment-based thermal management according to aspects described herein.

At operation 310, candidate features of the environment are re-evaluated. In examples, operation 310 is performed sometime after operation 308 (e.g., after a predetermined amount of time has elapsed or in response to an event, such as a change in the heat output of the vehicle or determining that a temperature sensor of the vehicle indicates a temperature that exceeds a threshold). In other examples, candidate features may be repeatedly evaluated. Aspects of operation 310 may be similar to those discussed above with respect to operations 302, 304, and 306 and are therefore not redescribed in detail.

At determination 312, it is determined whether a better candidate feature is available. Determination 312 may comprise evaluating a feature that was selected at operation 310 (e.g., as a result of performing aspects similar to those discussed above with respect to operations 304 and 306) as compared to the previously selected feature (e.g., that was selected at operation 306). In examples, the thermal conditions and/or associated thermal effect of the previously selected feature were updated as a result of re-evaluating the candidate features of the environment, such that the comparison of the newly selected candidate feature and the previously selected candidate feature is performed based on an updated or substantially current representation of the environment.

Determination 312 may comprise determining whether the currently selected feature and the previously selected feature are the same, in which case it would be determined that a better candidate feature is not available. In another example, determination 312 may comprise evaluating a relative benefit of the newly selected feature as compared to the previously selected feature, such that a relative benefit below a predetermined threshold would still yield a determination that a better candidate feature is not available. This may avoid expending resources to maneuver to a different feature offering only a marginal improvement.

If it is determined that a better candidate feature is not available, flow branches “NO” and returns to operation 310. In examples where it is determined that a better candidate feature is not available, the vehicle may still be reoriented in relation to the same candidate feature (e.g., rotated about an axis or the candidate feature, as illustrated by faces 204A and 204B in FIG. 2), as may be the case when the Sun shifts in the sky or other aspects of the environment have changed over time. In some instances, vehicle reorientation may occur separately from candidate feature evaluation. For instance, a vehicle may evaluate whether to reorient itself at a higher frequency than the evaluation as to whether a better candidate feature is available.

If, however, it is determined that a better candidate feature is available, flow instead branches “YES” to operation 314, where the vehicle maneuvers to the newly selected candidate feature. Aspects of operation 314 may be similar to those discussed above with respect to operation 308 and are therefore not redescribed in detail. Thus, flow may loop between operations 310, 312, and 314, thereby providing environment-based thermal management for the vehicle according to aspects described herein.

FIG. 3B illustrates an overview of another example method 350 for environment-based thermal management according to aspects described herein. In examples, aspects of method 300 are performed by a thermal manager, such as thermal manager 114 in FIG. 1. Aspects of method 350 may be performed by a vehicle (e.g., vehicle 100) among any of a variety of other hardware.

As compared to method 300, method 350 may be performed while navigating to a destination location, such that candidate features are identified and selected along a path to the destination location. Thus, the vehicle navigates to the destination location via selected candidate features, thereby managing the temperature of the vehicle accordingly (e.g., by exposing the vehicle to warmer or colder candidate features, or by shielding the vehicle from the Sun or deep space).

Method 300 begins at operation 352, where a destination location is determined. In examples, the destination location is determined by a vehicle controller (e.g., vehicle controller 102 of vehicle 100 in FIG. 1). As another example, the destination location is determined based on an indication that is received from a remote computing device (e.g., as may be received via a communication system, such as communication system 108).

At operation 354, a set of candidate environmental features is generated for thermal management. For instance, the set of candidate features may be generated based on image data of the environment and/or based on a 3D representation of the environment. As another example (e.g., where such detailed environment information is not available), the set of candidate environmental features may be generated based on a temperature gradient (e.g., as may be detected based on a network of thermal sensors). In such an example, the candidate features may correspond to directions of travel of the vehicle.

In examples, the set of candidate environmental features may be generated based at least in part on the destination location that was determined at operation 352. As an example, candidate features within a subregion of the environment are evaluated, such as a subregion that is in a general direction (e.g., within a range of bearings based on the current heading of the vehicle) of the destination location. For instance, candidate locations from 90 degrees left to 90 degrees right may be evaluated, thereby evaluating candidate locations within a 180 degree field of view from the perspective of the front of the vehicle. As another example, a smaller region may be evaluated, as may be the case to achieve more direct travel toward the destination location. Similarly, a larger region may be evaluated, as may be the case when thermal management may be prioritized over direct travel toward the destination location.

Method 350 progresses to operation 356, where the candidate features are ranked according to associated thermal conditions (e.g., in view of a thermal goal, as described above). For instance, a surface temperature, geometry, absorptivity, and/or emissivity of the candidate feature may be evaluated to determine an expected thermal effect that the candidate feature would have on the vehicle. In examples, operation 356 comprises obtaining information relating to such thermal conditions using sensors (e.g., sensors 110 in FIG. 1). The expected thermal effect may be generated based on one or more models (e.g., as may be maintained by a thermal manager and/or received from a remote computing device).

In other examples, candidate features are ranked according to an associated temperature (e.g., as may be the case when a temperature sensors are used to evaluate the environment of the vehicle). In some examples, candidate features are further ranked according to an associated cost, such that a benefit associated with a given candidate feature (e.g., an estimated thermal effect or an associated temperature) is offset based on an associated cost (e.g., the cost of maneuvering to/from the candidate feature, a restriction on vehicle mobility or other functionality, or a reduced ability to perform aspects of a given mission). Similarly, the candidate features may be ranked according to an effect on a path toward the destination location. For example, a candidate feature that constitutes a larger detour from a path toward the destination location may be ranked lower than a candidate feature that is more direct, especially in instances where the candidate features are otherwise similar (e.g., having a similar thermal effect and/or cost). Thus, it will be appreciated that candidate features may be ranked according to any of a variety of criteria.

At operation 358, a candidate feature is selected for thermal management. In examples, operation 358 comprises identifying the highest ranked candidate feature from the set of candidate features that was generated at operation 356. While method 350 is provided as an example where candidate features are ranked and selected accordingly, it will be appreciated that any of a variety of other techniques may be used to select a candidate feature from a set of candidate features. Additionally, while examples are described with respect to a single candidate feature, it will be appreciated that similar techniques may be used to select multiple candidate features (e.g., proximal to one another) with which to perform environment-based thermal management according to aspects described herein.

For example, the set of candidate features may be evaluated according to a set of rules. The set of rules may filter the set of candidate features (e.g., according to one or more thermal conditions, a direction of travel, a temperature threshold, or an associated cost), such that the remaining candidate features are evaluated at operation 358. In such an example, the remaining candidate features may be evaluated to determine which candidate feature has the lowest associated cost or the highest expected thermal effect, though any of a variety of additional or alternative criteria may be used in other examples.

Flow progresses to operation 360, where the vehicle maneuvers to the candidate feature that was selected at operation 358. In examples, operation 360 comprises providing an indication to a movement controller (e.g., movement controller 116 of vehicle controller 102 in FIG. 1), thereby causing the vehicle to maneuver to the selected candidate feature accordingly.

At determination 362, it is determined whether the vehicle has arrived at the destination location. If it is determined that the vehicle has arrived, flow branches “YES” and terminates at operation 364. However, if it is determined that the vehicle has not arrived at the destination location, flow instead branches “NO” and returns to operation 354. Thus, method 350 may iterate through operations 354, 356, 358, 360, and 362 while navigating to the determined destination location so as to provide environment-based thermal management while traversing a planetary body.

In examples, determination 362 may be made once the vehicle has finished maneuvering to the candidate feature that was selected at operation 360. In other examples, determination 362 may be made prior to arriving at the selected candidate feature, such that the vehicle may repeatedly or substantially continuously evaluate its environment. For instance, as the vehicle traverses the planetary body, a different candidate feature may be selected at operation 358 (e.g., in a subsequent iteration of the above-described operations), thereby causing the vehicle to alter its course to the newly selected candidate feature on its way toward destination location. Eventually, method 350 terminates at operation 364.

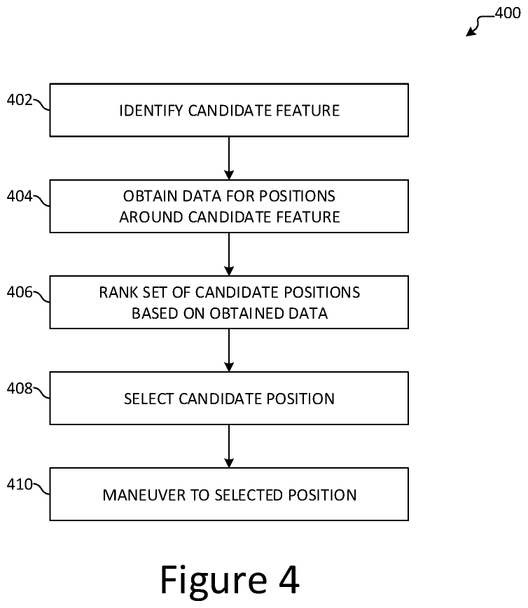

FIG. 4 illustrates an overview of an example method 400 for evaluating candidate positions around a candidate feature according to aspects described herein. In an example, aspects of method 400 are performed by a thermal manager, such as thermal manager 114 in FIG. 1. For instance, aspects of method 400 may be performed by a vehicle (e.g., vehicle 100) among any of a variety of other hardware.

Aspects of method 400 may be performed to evaluate a candidate feature (e.g., as may be selected as part of method 300 or 350 discussed above with respect to FIGS. 3A and 3B, respectively). For instance, once a vehicle has selected a candidate feature, the candidate feature may be further evaluated (e.g., after the vehicle has maneuvered to the feature) to identify a location and/or orientation of the vehicle with respect to the selected feature. With reference to FIG. 2, a vehicle may perform method 400 to evaluate environmental feature 204, similar to aspects discussed above with respect to path 212. As a result of performing the described aspects, the vehicle may distinguish between first side 204A and second side 204B and select a side according to whether the vehicle is to be heated or cooled.

At operation 402, a candidate feature is identified. Aspects of operation 402 may be similar to those discussed above with respect to operations 302, 304, and 306 or operations 354, 356, and 358 of method 300 in FIG. 3A or method 350 in FIG. 3B, respectively. Accordingly, such aspects are not necessarily redescribed in detail. As an example, operation 402 comprises selecting an identified environmental feature according to aspects described herein. As another example, operation 402 comprises evaluating a temperature gradient (e.g., to determine a direction of travel for the vehicle).

Flow progresses to operation 404, where data is obtained for one or more candidate positions around the identified candidate feature. In examples, operation 404 comprises maneuvering around at least a part of the identified feature, such that data associated with various candidate positions is collected. An example of such aspects was discussed above with respect to path 212 in FIG. 2. It will be appreciated that a vehicle may follow any of a variety of paths to obtain data relating to one or more positions around the identified features.

Additionally, while examples are described in which the vehicle maneuvers to the candidate feature to further survey the feature, it will be appreciated that data associated with various positions around the identified feature may be obtained using any of a variety of other techniques. For instance, the data may be obtained from a different device (e.g., from a remote computing device or from another vehicle). As another examples, the data may be obtained via one or more sensors of the vehicle (e.g., sensors 110), as may be the case when an image capture device is used to higher resolution data of the environment (e.g., compared to one or more thermal sensors). Further, similar techniques may be used to survey multiple environmental features, as may be the case when a grouping of environmental features is identified at operation 402.

At operation 406, the candidate positions are ranked based on the obtained data (e.g., in view of a thermal goal, as described above). Similar to ranking candidate features, operation 406 may comprise evaluating associated thermal conditions. For example, a surface temperature, geometry, absorptivity, and/or emissivity of the identified feature at the candidate position (e.g., as may have been obtained at operation 404) may be evaluated to determine an expected thermal effect that the candidate feature would have on the vehicle if the vehicle were located at the candidate position. As noted above, the expected thermal effect may be generated based on one or more models (e.g., as may be maintained by a thermal manager and/or received from a remote computing device).

Thus, candidate positions may be ranked according to an associated thermal effect or, as another example, according to an associated temperature to which the vehicle would be subjected if located at a given candidate position. In some examples, candidate positions are further ranked according to an associated cost, such that a benefit associated with a given candidate position (e.g., an estimated thermal effect or an associated temperature) is offset based on an associated cost (e.g., the cost of maneuvering to/from the candidate position, a restriction on vehicle mobility or other functionality, or a reduced ability to perform aspects of a given mission). Thus, it will be appreciated that candidate positions may be ranked according to any of a variety of criteria.

Flow progresses to operation 408, where a candidate position is selected. In examples, operation 408 comprises identifying the highest ranked candidate position from the set of candidate positions that was ranked at operation 406. While method 400 is provided as an example where candidate positions are ranked and selected accordingly, it will be appreciated that any of a variety of other techniques may be used to select a candidate position from a set of candidate positions. For example, the set of candidate positions may be evaluated according to a set of rules that filters the set of candidate positions (e.g., according to one or more thermal conditions, a direction of travel, a temperature threshold, or an associated cost), such that the remaining candidate positions are evaluated at operation 408. In such an example, the remaining candidate positions may be evaluated to determine which candidate position has the lowest associated cost or the highest expected thermal effect. Any of a variety of additional or alternative criteria may be used in other examples.

Method 400 progresses to operation 410, where the vehicle maneuvers to the position that was selected at operation 410. In examples, operation 410 comprises providing an indication to a movement controller (e.g., movement controller 116 of vehicle controller 102 in FIG. 1), thereby causing the vehicle to maneuver to the selected candidate feature accordingly. In examples, the position to which the vehicle maneuvers is different than positions for which data was obtained, as may be the case when the obtained data is used to generate a gradient or heat map for the candidate feature, such that the position to which the vehicle maneuvers is instead determined based on the gradient or heat map accordingly. Method 400 terminates at operation 410.

It will be appreciated that method 400 is provided as an example method for evaluating a candidate feature and, in other examples, any of a variety of additional or alternative techniques may be used. For example, if data associated with a candidate feature has been previously collected, the previously collected data may be used to determine a candidate position accordingly. As another example, one or more positions of a candidate feature may be modeled based on data obtained from one or more other similar candidate features.

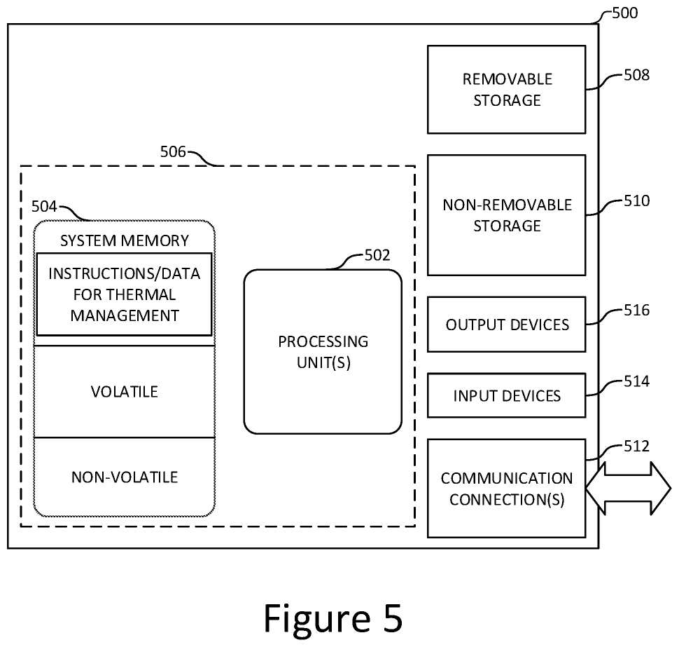

FIG. 5 illustrates an example of a suitable computing environment 500 in which one or more of the present embodiments may be implemented. For example, aspects of computing environment 500 may be used by a controller, such as vehicle controller 102 in FIG. 1. This is only one example of a suitable computing environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, computing environment 500 typically may include at least one processing unit 502 and memory 504. Depending on the exact configuration and type of computing device, memory 504 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 5 by dashed line 506. Further, environment 500 may also include storage devices (removable, 508, and/or non-removable, 510) including, but not limited to, magnetic or optical disks or tape. Similarly, environment 500 may also have input device(s) 514 such as a keyboard, mouse, pen, voice input, etc. and/or output device(s) 516 such as a display, speakers, printer, etc. Also included in the environment may be one or more communication connections, 512, such as LAN, WAN, point to point, etc.

Computing environment 500 may include at least some form of computer readable media. The computer readable media may be any available media that can be accessed by processing unit 502 or other devices comprising the computing environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The computing environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets, and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 504. While executing on the processing unit 502, program modules (e.g., applications, Input/Output (I/O) management, and other utilities) may perform processes including, but not limited to, one or more of the stages of the operational methods described herein.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing environment 500 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

As will be understood from the foregoing disclosure, one aspect of the technology relates to a vehicle. The vehicle comprises: a plurality of ground-engaging members; and a controller supported by the plurality of ground-engaging members, comprising: a processor; and a memory storing instructions that, when executed by the processor, cause the controller to perform a set of operations. The set of operations comprises: identifying a set of candidate features in an environment of the vehicle; ranking, based on a thermal goal for the vehicle and a thermal condition for each candidate feature of the set of candidate features, the set of candidate features; selecting, from the ranked set of candidate features, a candidate feature of the environment to manage a temperature of the vehicle; and generating an indication to maneuver the vehicle to the selected candidate feature. In an example, the set of candidate features is identified based on at least one of: one or more temperature sensors of the vehicle; data from an image capture device of the vehicle; or data from a light detection and ranging (LIDAR) system of the vehicle. In another example, ranking the set of candidate features comprises generating, for each candidate feature, an estimated thermal effect of the feature on the vehicle based on the thermal condition for the candidate feature. In a further example, ranking the set of candidate features comprises determining, for each candidate feature, an associated cost associated with the candidate feature. In yet another example, the thermal goal for the vehicle is determined based on: a temperature sensor of the vehicle corresponding to the temperature; and a minimum operating temperature or a maximum operating temperature associated with the temperature sensor. In a further still example, the set of operations further comprises: evaluating a set of candidate positions for the selected candidate feature; and selecting a position from the set of candidate positions; and the indication to maneuver the vehicle to the selected candidate feature further comprises an indication of the selected position. In another example, evaluating the set of candidate positions comprises generating an indication to maneuver the vehicle to a position of the set of candidate positions, thereby obtaining data associated with the candidate feature from the position.

In another aspect, the technology relates to a method for thermal management of a vehicle traversing an environment. The method comprises: determining a destination location in the environment; identifying, based on the destination location, a set of candidate features in the environment; determining, based on an estimated thermal effect for each candidate feature of the set of candidate features, a feature of the environment to manage a temperature of the vehicle; and generating, as part of maneuvering the vehicle toward the destination, an indication to maneuver the vehicle to the determined feature. In an example, determining the feature comprises: ranking, based on the destination location and the estimated thermal effect for each candidate feature, the set of candidate features; and selecting, from the ranked set of candidate features, the candidate feature of the environment. In another example, the set of candidate features is identified based at least in part on a range of bearings in relation to a heading of the vehicle. In a further example, the estimated thermal effect for each candidate feature is generated using a model based on a thermal condition for the candidate feature. In yet another example, determining the feature comprises determining a position for the vehicle relative to the determined feature; and the indication to maneuver the vehicle to the determined feature further comprises an indication of the determined position. In a further still example, the location is determined based on an indication that is received via a communication system of the vehicle.

In a further aspect, the technology relates to computer storage media. The computer storage media stores instructions that, when executed by a processor, cause the processor to: identify a first set of candidate features in an environment of a vehicle; determine, from the first set of candidate features, a first feature of the environment to manage a temperature of the vehicle; generate an indication to maneuver the vehicle to the first feature of the environment; identify a second set of candidate features in the environment; determine, from the second set of candidate features, a second feature of the environment to manage the temperature of the vehicle; and based on determining the second feature has an improved thermal effect compared to the first feature, generate an indication to maneuver the vehicle from the first feature to the second feature of the environment. In an example, the first set of candidate features and the second set of candidate features are identified based on at least one of: one or more temperature sensors of the vehicle; data from an image capture device of the vehicle; or data from a light detection and ranging (LIDAR) system of the vehicle. In another example, the first feature and the second feature are each determined based on a model that generates an estimated thermal effect for a given thermal condition of a feature of the environment. In a further example, the first feature and the second feature are each determined based on a model that generates an estimated thermal effect for a given thermal condition of a feature of the environment. In yet another example, the first feature is determined based on a first thermal goal and the second feature is determined based on a second thermal goal. In a further still example, the first thermal goal is determined based on: a temperature sensor of the vehicle corresponding to the temperature; and a minimum operating temperature or a maximum operating temperature associated with the temperature sensor. In an example, the first thermal goal and the second thermal goal are the same.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A vehicle, comprising:
a plurality of ground-engaging members; and
a controller supported by the plurality of ground-engaging members, comprising:
a processor; and
a memory storing instructions that, when executed by the processor, cause the controller to perform a set of operations, comprising:
identifying a set of candidate features in an environment of the vehicle;
ranking, based on a thermal goal for the vehicle and a thermal condition for each candidate feature of the set of candidate features, the set of candidate features;
selecting, from the ranked set of candidate features, a candidate feature of the environment to manage a temperature of the vehicle; and
generating an indication to maneuver the vehicle to the selected candidate feature.

2. The vehicle of claim 1, wherein the set of candidate features is identified based on at least one of:
one or more temperature sensors of the vehicle;
data from an image capture device of the vehicle; or
data from a light detection and ranging (LIDAR) system of the vehicle.

3. The vehicle of claim 1, wherein ranking the set of candidate features comprises generating, for each candidate feature, an estimated thermal effect of the feature on the vehicle based on the thermal condition for the candidate feature.

4. The vehicle of claim 1, wherein ranking the set of candidate features comprises determining, for each candidate feature, an associated cost associated with the candidate feature.

5. The vehicle of claim 1, wherein the thermal goal for the vehicle is determined based on:
a temperature sensor of the vehicle corresponding to the temperature; and
a minimum operating temperature or a maximum operating temperature associated with the temperature sensor.

6. The vehicle of claim 1, wherein:
the set of operations further comprises:
evaluating a set of candidate positions for the selected candidate feature; and
selecting a position from the set of candidate positions; and
the indication to maneuver the vehicle to the selected candidate feature further comprises an indication of the selected position.

7. The vehicle of claim 6, wherein evaluating the set of candidate positions comprises generating an indication to maneuver the vehicle to a position of the set of candidate positions, thereby obtaining data associated with the candidate feature from the position.

8. A method for thermal management of a vehicle traversing an environment, the method comprising:
determining a destination location in the environment;
identifying, based on the destination location, a set of candidate features in the environment;
determining, based on an estimated thermal effect for each candidate feature of the set of candidate features, a feature of the environment to manage a temperature of the vehicle; and
generating, as part of maneuvering the vehicle toward the destination, an indication to maneuver the vehicle to the determined feature.

9. The method of claim 8, wherein determining the feature comprises:
ranking, based on the destination location and the estimated thermal effect for each candidate feature, the set of candidate features; and
selecting, from the ranked set of candidate features, the candidate feature of the environment.

10. The method of claim 8, wherein the set of candidate features is identified based at least in part on a range of bearings in relation to a heading of the vehicle.

11. The method of claim 8, wherein the estimated thermal effect for each candidate feature is generated using a model based on a thermal condition for the candidate feature.

12. The method of claim 8, wherein:
determining the feature comprises determining a position for the vehicle relative to the determined feature; and
the indication to maneuver the vehicle to the determined feature further comprises an indication of the determined position.

13. The method of claim 8, wherein the location is determined based on an indication that is received via a communication system of the vehicle.

14. A computer storage media storing instructions that, when executed by a processor, cause the processor to:
identify a first set of candidate features in an environment of a vehicle;
determine, from the first set of candidate features, a first feature of the environment to manage a temperature of the vehicle;
generate an indication to maneuver the vehicle to the first feature of the environment;
identify a second set of candidate features in the environment;
determine, from the second set of candidate features, a second feature of the environment to manage the temperature of the vehicle; and
based on determining the second feature has an improved thermal effect compared to the first feature, generate an indication to maneuver the vehicle from the first feature to the second feature of the environment.

15. The computer storage media of claim 14, wherein the first set of candidate features and the second set of candidate features are identified based on at least one of:
one or more temperature sensors of the vehicle;
data from an image capture device of the vehicle; or
data from a light detection and ranging (LIDAR) system of the vehicle.

16. The computer storage media of claim 14, wherein the first feature and the second feature are each determined based on a model that generates an estimated thermal effect for a given thermal condition of a feature of the environment.

17. The computer storage media of claim 14, wherein the instructions determine that the second feature has an improved thermal effect compared to the first feature before the vehicle arrives at the first feature.

18. The computer storage media of claim 14, wherein the first feature is determined based on a first thermal goal and the second feature is determined based on a second thermal goal.

19. The computer storage media of claim 18, wherein the first thermal goal is determined based on:
a temperature sensor of the vehicle corresponding to the temperature; and
a minimum operating temperature or a maximum operating temperature associated with the temperature sensor.

20. The computer storage media of claim 18, wherein the first thermal goal and the second thermal goal are the same.
